(19) United States
(12) Patent Application Publication
(10) Pub. No.: US 2023/0128225 A1
(43) Pub. Date: Apr. 27, 2023

(54) Methods and Apparatus for Network Initiated Mobility In Networks

(71) Applicant: Huawei Technologies Co., Ltd., Shenzhen (CN)

(72) Inventors: Zhixian Xiang, Frisco, TX (US); Khosrow Tony Saboorian, Plano, TX (US); Kaippallimalil Mathew John, carrollton, TX (US)

(21) Appl. No.: 17/982,110

(22) Filed: Nov. 7, 2022

Related U.S. Application Data
(63) Continuation of application No. PCT/US2021/023325, filed on Mar. 19, 2021.
(60) Provisional application No. 63/021,460, filed on May 7, 2020.

(51) Int. Cl. H04W 48/18; H04W 48/16; H04W 24/10; H04B 17/318

(52) U.S. Cl. CPC H04W 48/18; H04W 48/16; H04W 24/10; H04B 17/318

(57) ABSTRACT

A method for implemented by a user equipment (UE) receiving, by the UE from a home service provider (SP) of the UE, a first message including information associated with one or more target networks, the first message initiating a network switch changing a serving network of the UE from a current network to one target network of the one or more target networks; selecting, by the UE, the one target network of the one or more target networks; and accessing, by the UE, the one target network.

### CROSS-REFERENCE TO RELATED APPLICATIONS

This application is a continuation of International Application No. PCT/US2021/023325, filed Mar. 19, 2021, entitled “Methods and Apparatus for Network Initiated Mobility In Networks,” which claims the benefit of U.S. Provisional Application No. 63/021,460, filed on May 7, 2020, entitled “Methods and Apparatus for Network Initiated Continuity of SNPN Deployments,” applications of which are hereby incorporated herein by reference in their entireties.

### TECHNICAL FIELD

The present disclosure relates generally to methods and apparatus for digital communications, and, in particular embodiments, to methods and apparatus for network initiated mobility in networks.

### BACKGROUND

Mobility management generally refers to functions of a communication network intended to support the movement of subscribers (e.g., user equipments (UEs)), allowing the continuous delivery of services, such as calls, content, data, messages, and so on, to the subscribers as the subscribers move about the communication system. As the services offered by communication networks become more complicated and requirements become more stringent, the tasks involved with mobility management also become harder to implement.

A stand-alone non-public networks (SNPN) is a network operated by a non-public network (NPN) operator that does not rely on network functions provided by a public-line mobile network (PLMN). In other words, a SNPN enables the deployment of a Fifth Generation (5G) network for private use, with no dependencies to public 5G networks.

However, because UEs remain mobile, it is possible for a UE to exit the coverage of a first SNPN into the coverage of a second SNPN. Therefore, there is a need for methods and apparatus for network initiated mobility in non-public networks, such as SNPNs.

### SUMMARY

According to a first aspect, a method implemented by a user equipment (UE) is provided. The method comprising: receiving, by the UE from a home service provider (SP) of the UE, a first message including information associated with one or more target networks, the first message initiating a network switch changing a serving network of the UE from a current network to one target network of the one or more target networks; selecting, by the UE, the one target network of the one or more target networks; and accessing, by the UE, the one target network.

In a first implementation form of the method according to the first aspect, the home SP owning a service subscription of the UE for a service or application the UE is accessing through the serving network.

In a second implementation form of the method according to the first aspect or any preceding implementation form of the first aspect, the one or more target networks comprising private networks belonging to SPs different from the home SP.

In a third implementation form of the method according to the first aspect or any preceding implementation form of the first aspect, the first message comprising a network switch indication or a network steering indication.

In a fourth implementation form of the method according to the first aspect or any preceding implementation form of the first aspect, further comprising: receiving, by the UE from the home SP, a second message including network information associated with one or more candidate networks of a network switch involving the UE, the second message being received prior to receiving the first message; measuring, by the UE, the one or more candidate networks in accordance with the network information; and reporting, by the UE to the home SP, measurement information associated with the one or more candidate networks.

In a fifth implementation form of the method according to the first aspect or any preceding implementation form of the first aspect, the first message or the second message being received in one of a UE configuration procedure or a parameter update procedure.

In a sixth implementation form of the method according to the first aspect or any preceding implementation form of the first aspect, the first message being received in a dedicated network control message steering the UE from the current network to the one target network.

In a seventh implementation form of the method according to the first aspect or any preceding implementation form of the first aspect, the first message being received in a policy configuration message steering the UE from the current network to the one target network based on a service connectivity policy.

In an eighth implementation form of the method according to the first aspect or any preceding implementation form of the first aspect, the first message further comprising a time window duration for completing or start the network switch process.

In a ninth implementation form of the method according to the first aspect or any preceding implementation form of the first aspect, when the time window duration is equal to zero, the UE starts the network switch network process as soon as possible.

In a tenth implementation form of the method according to the first aspect or any preceding implementation form of the first aspect, the second message comprising a UE network switch policy.

In an eleventh implementation form of the method according to the first aspect or any preceding implementation form of the first aspect, the first message comprising a network switch policy to assist the UE make a switch decision.

In a twelfth implementation form of the method according to the first aspect or any preceding implementation form of the first aspect, the network switch policy comprising a performance threshold or a location trigger for UE to start the switch.

In a thirteenth implementation form of the method according to the first aspect or any preceding implementation form of the first aspect, the performance threshold comprising an application level performance.

In a fourteenth implementation form of the method according to the first aspect or any preceding implementation form of the first aspect, the network information comprising identifiers of the one or more candidate networks, and identifiers of one or more SPs of the one or more candidate networks.

In a fifteenth implementation form of the method according to the first aspect or any preceding implementation form of the first aspect, the measurement information comprising, for each one of the one or more candidate networks, an indicator indicating if a signal strength of the candidate network is suitable for the UE.

According to a second aspect, a method implemented by a home service provider (SP) is provided. The method comprising: receiving, by the home SP from a user equipment (UE), a report including information associated with a location of the UE; selecting, by the home SP, one or more target networks in accordance with the information; and sending, by the home SP to the UE, a first message including information associated with the one or more target networks, the second message initiating a network switch changing a serving network of the UE from a current network to one target network of the one or more target networks.

In a first implementation form of the method according to the second aspect, further comprising sending, by the home SP to the UE, a second message including a measurement request for one or more candidate networks.

In a second implementation form of the method according to the second aspect or any preceding implementation form of the second aspect, the home SP owning a service subscription of the UE for a service or application the UE is accessing through the serving network.

In a third implementation form of the method according to the second aspect or any preceding implementation form of the second aspect, the one or more target networks comprising private networks belonging to SPs different from the home SP.

In a fourth implementation form of the method according to the second aspect or any preceding implementation form of the second aspect, the first message being sent in one of a procedure for UE configuration or a parameter update procedure.

In a fifth implementation form of the method according to the second aspect or any preceding implementation form of the second aspect, the first message being sent in a dedicated network control message for steering the UE from the current network to the one target network.

In a sixth implementation form of the method according to the second aspect or any preceding implementation form of the second aspect, the first message being sent in a policy configuration message for steering the UE from the current network to the one target network based on a service connectivity policy.

In a seventh implementation form of the method according to the second aspect or any preceding implementation form of the second aspect, the information comprising location information of the UE.

In an eighth implementation form of the method according to the second aspect or any preceding implementation form of the second aspect, further comprising:

determining, by the SP, one or more candidate networks in accordance with the location information of the UE and a distance threshold; and

querying, by the SP, the one or more candidate networks to obtain performance information associated with the one or more candidate networks.

In a ninth implementation form of the method according to the second aspect or any preceding implementation form of the second aspect, the information comprising performance information associated with one or more candidate networks determined by the UE.

In a tenth implementation form of the method according to the second aspect or any preceding implementation form of the second aspect, the one or more target networks being selected from the one or more candidate networks in accordance with the performance information.

In an eleventh implementation form of the method according to the second aspect or any preceding implementation form of the second aspect, the performance information comprising an indicator indicating a signal strength of each of the at least one candidate network being suitable for the UE.

According to a third aspect, a UE is provided. The UE comprising: one or more processors; and a non-transitory memory storage comprising instructions that, when executed by the one or more processors, cause the UE to: receive, from a home service provider (SP) of the UE, a first message including information associated with one or more target networks, the first message initiating a network switch changing a serving network of the UE from a current network to one target network of the one or more target networks; select the one target network of the one or more target networks; and access the one target network.

In a first implementation form of the UE according to the third aspect, the home SP owning a service subscription of the UE for a service or application the UE is accessing through the serving network.

In a second implementation form of the UE according to the third aspect or any preceding implementation form of the third aspect, the one or more target networks comprising private networks belonging to SPs different from the home SP.

In a third implementation form of the UE according to the third aspect or any preceding implementation form of the third aspect, the first message comprising a network switch indication or a network steering indication.

In a fourth implementation form of the UE according to the third aspect or any preceding implementation form of the third aspect, the instructions causing the UE to: receive, from the home SP, a second message including network information associated with one or more candidate networks of a network switch involving the UE, the second message being received prior to receiving the first message; measure the one or more candidate networks in accordance with the network information; and report, to the home SP, measurement information associated with the one or more candidate networks.

In a fifth implementation form of the UE according to the third aspect or any preceding implementation form of the third aspect, the first message or the second message being received in one of a UE configuration procedure or a parameter update procedure.

In a sixth implementation form of the UE according to the third aspect or any preceding implementation form of the third aspect, the first message being received in a dedicated network control message steering the UE from the current network to the one target network.

In a seventh implementation form of the UE according to the third aspect or any preceding implementation form of the third aspect, the first message being received in a policy configuration message steering the UE from the current network to the one target network based on a service connectivity policy.

In an eighth implementation form of the UE according to the third aspect or any preceding implementation form of the third aspect, the first message further comprising a time window duration for completing or start the network switch process.

In a ninth implementation form of the UE according to the third aspect or any preceding implementation form of the third aspect, the second message comprising a UE network switch policy.

In a tenth implementation form of the UE according to the third aspect or any preceding implementation form of the third aspect, the first message comprising a network switch policy to assist the UE make a switch decision.

In an eleventh implementation form of the UE according to the third aspect or any preceding implementation form of the third aspect, the network switch policy comprising a performance threshold or a location trigger for UE to start the switch.

In a twelfth implementation form of the UE according to the third aspect or any preceding implementation form of the third aspect, the performance threshold comprising an application level performance.

In a thirteenth implementation form of the UE according to the third aspect or any preceding implementation form of the third aspect, the network information comprising identifiers of the one or more candidate networks, and identifiers of one or more SPs of the one or more candidate networks.

In a fourteenth implementation form of the UE according to the third aspect or any preceding implementation form of the third aspect, the measurement information comprising, for each one of the one or more candidate networks, an indicator indicating if a signal strength of the candidate network is suitable for the UE.

An advantage of an example embodiment is that network initiated mobility in non-public networks is supported. Information provided by the network initiates and assists mobility to improve mobility performance.

Yet another advantage of an example embodiment is that the information provided by the network assists the UE in collecting information associated with potential target networks, which may help to improve mobility performance.

### BRIEF DESCRIPTION OF THE DRAWINGS

: For a more complete understanding of the present disclosure, and the advantages thereof, reference is now made to the following descriptions taken in conjunction with the accompanying drawings, in which:

FIG. 1 illustrates a first example communications system;

FIG. 2 illustrates a communication system highlighting a network switch;

FIG. 3A illustrates a communication system highlighting a UE obtaining service from service provider (SP) through stand-alone non-private network (SNPN) #1;

FIG. 3B illustrates a communication system highlighting UE 305 obtaining service from SP (SP #1) through a NPN (which includes its own radio access network (RAN) and 5G core (5GC));

FIG. 4 illustrates a communication system highlighting the prior art technique supporting UE mobility;

FIG. 5 illustrates a diagram of communications exchanged and processing performed by entities participating in the prior art technique supporting UE mobility;

FIG. 6 illustrates a high-level view of a communication system with support for network initiated mobility in NPNs according to example embodiments presented herein;

FIG. 7 illustrates the architecture of a first example communication system highlighting entities with enhanced operation to support network initiated mobility according to example embodiments presented herein;

FIG. 8 illustrates the architecture of a second example communication system highlighting entities with enhanced operation to support network initiated mobility according to example embodiments presented herein;

FIG. 9 illustrates a diagram of communications exchanged and processing performed by entities participating in a UE reporting potential target networks procedure according to example embodiments presented herein;

FIG. 10 illustrates a diagram of communications exchanged and processing performed by entities participating in a first example network triggered network switch according to example embodiments presented herein;

FIG. 11 illustrates a diagram of communications exchanged and processing performed by entities participating in a second example network triggered network switch according to example embodiments presented herein;

FIG. 12 illustrates a flow diagram of example operations occurring in a UE participating in network initiated mobility according to example embodiments presented herein;

FIG. 13 illustrates a flow diagram of example operations occurring in a SP participating in network initiated mobility according to example embodiments presented herein;

FIG. 14 illustrates a flow diagram of example operations occurring in a SP initiating network initiated mobility according to example embodiments presented herein;

FIG. 15 illustrates an example communication system according to example embodiments presented herein;

FIGS. 16A and 16B illustrate example devices that may implement the methods and teachings according to this disclosure; and

FIG. 17 is a block diagram of a computing system that may be used for implementing the devices and methods disclosed herein.

### DETAILED DESCRIPTION OF ILLUSTRATIVE EMBODIMENTS

The structure and use of disclosed embodiments are discussed in detail below. It should be appreciated, however, that the present disclosure provides many applicable concepts that can be embodied in a wide variety of specific contexts. The specific embodiments discussed are merely illustrative of specific structure and use of embodiments, and do not limit the scope of the disclosure.

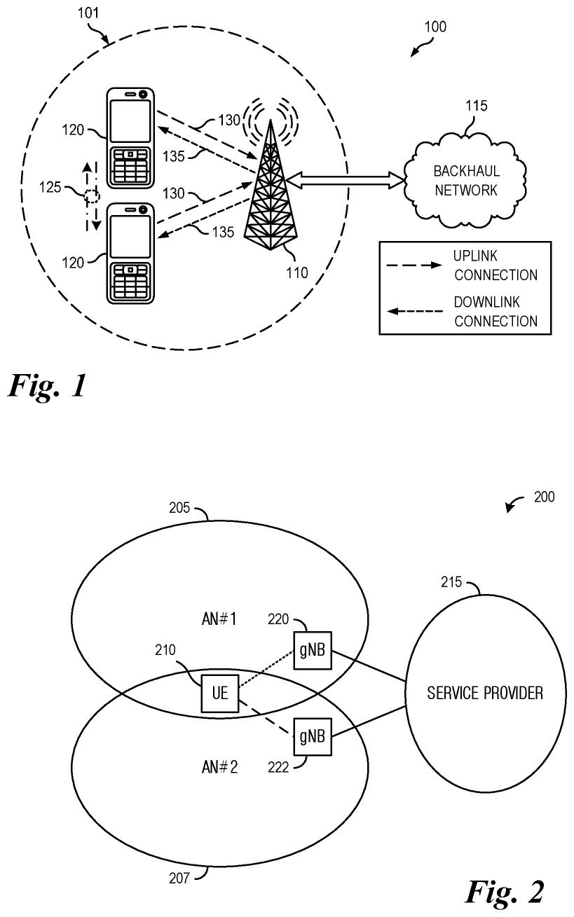

FIG. 1 illustrates a first example communications system 100. Communications system 100 includes an access node 110, with coverage area 101, serving user equipments (UEs), such as UEs 120. Access node 110 is connected to a backhaul network 115 that provides connectivity to services and the Internet. In a first operating mode, communications to and from a UE passes through access node 110. In a second operating mode, communications to and from a UE do not pass through access node 110, however, access node 110 typically allocates resources used by the UE to communicate when specific conditions are met. Communication between a UE pair in the second operating mode occurs over sidelinks 125, comprising uni-directional communication links. Communication between a UE and access node pair also occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

Due to the mobile nature of UEs, it is common for a UE to exit the coverage area of a first network entity or access network (AN) and enter the coverage area of a second network entity or AN. In such a situation, a network switch is performed to move the UE from coverage of the first network entity or AN and into the second network entity or AN. A special case of a network switch is a handover (HO). In a HO, the UE typically moves from serving entities such as access nodes of a single network. FIG. 2 illustrates a communication system 200 highlighting a network switch. Communication system 200 includes a first AN (AN #1) 205 and a second AN (AN #2) 207. UE 210 is receiving services from service provider (SP) 215 through a connection with gNB 220.

However, because UE 210 is mobile, UE 210 moves towards the outer periphery of AN #1 205 and the quality of the connection gNB 220 drops. However, the deployment of communication system 200 is such that the coverage of AN #2 207 overlaps with the coverage of AN #1 205, and as UE 210 exits the coverage of AN #1 205, UE 205 is also entering the coverage of AN #2 207. Therefore, to continue receiving services from SP 215, UE 210 participates in a network switch to establish a new connection with SP 215 through gNB 222 of AN #2 207 while dropping the connection with gNB 220.

AN #1 205 and AN #2 207 of communication system 200 may be any of a variety of access networks, including public networks (PNs) (such as public-line mobile networks (PLMNs), and so on), non-public networks (NPNs), stand-alone NPNs (SNPNs), and so forth.

An area of study regarding network enhancements for private networks involves enhancements to support mobility in SNPNs, with a particular focus being given to credentials owned by an entity separate from the SNPN.

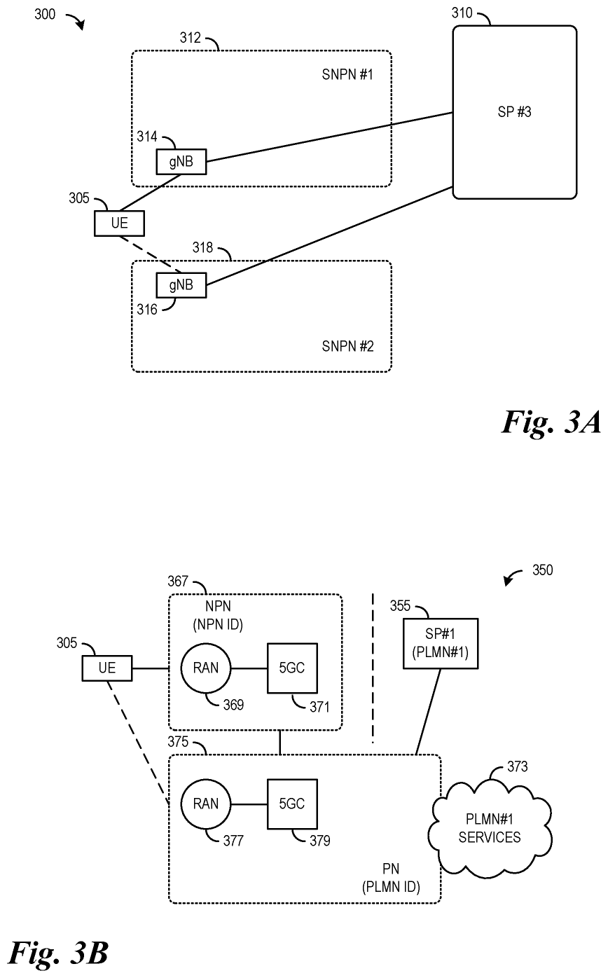

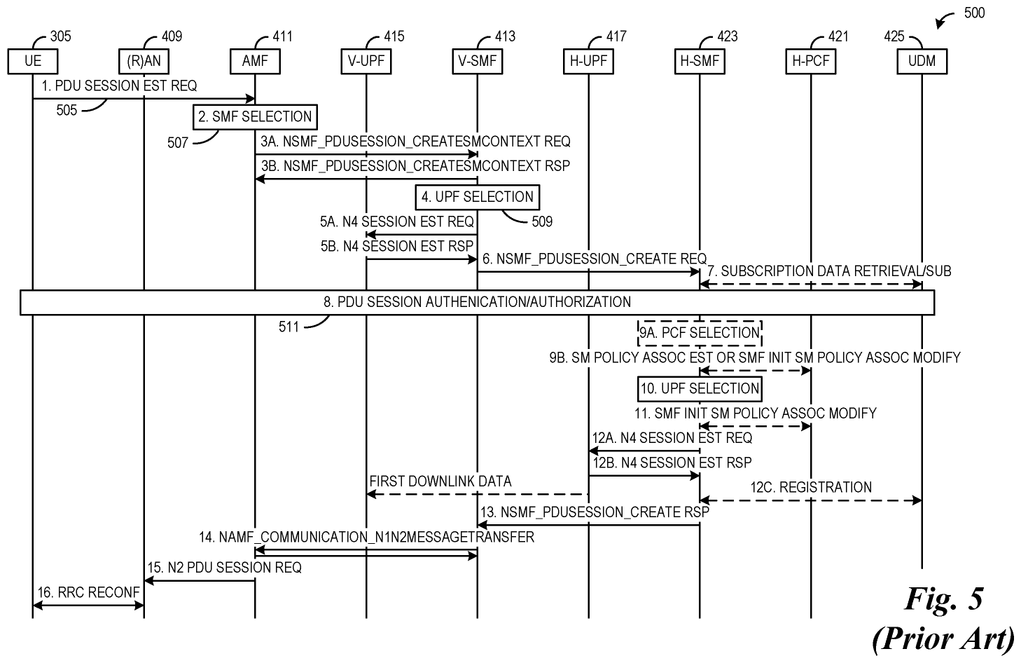

FIG. 3A illustrates a communication system 300 highlighting a UE 305 obtaining service from SP (SP #3) 310 through SNPN #1 312. As shown in FIG. 3A, UE 305 obtains service from SP 310 through gNB 314 of SNPN #1 312. However, as UE 305 moves, UE 305 has to continue obtaining service from SP 310 through gNB 316 of SNPN #2 318. In other words, UE 305 moves from gNB 314 of SNPN #1 312 to gNB 316 of SNPN #2 318 to continue service from SP 310, hence UE 305 participates in a network switch to switch from SNPN #1 312 to SNPN #2 318.

FIG. 3B illustrates a communication system 350 highlighting UE 305 obtaining service from SP (SP #1) 355 through a NPN 367 (which includes its own radio access network (RAN) 369 and 5G core (5GC) 371). Services 373, provided by SP 355 may include services provided by an Internet Protocol (IP) multimedia subsystem (IMS), for example. As shown in FIG. 3B, UE 305 obtains service from SP 355 through a connection through NPN 367 and PN 375 (which includes its own RAN 377 and 5GC 379). However, as UE 305 moves, UE 305 has to continue obtaining service from SP 355 but has moved away from NPN 367. In such a situation, UE 305 continues service from SP 355 through PN 375. In other words, UE 305 participates in a network switch from NPN 367 to PN 375.

A prior art technique supporting UE mobility entails a UE initiated protocol data unit (PDU) session establishment procedure involving the UE and a first SNPN being performed, with the first SNPN being a roaming visitor network (V-SNPN), while a data anchor for the UE is located in a home SP. The data anchor utilizes home routing. When the UE moves from the first SNPN to a second SNPN, the prior art technique operates as if the UE is moving from one V-SNPN to another V-SNPN.

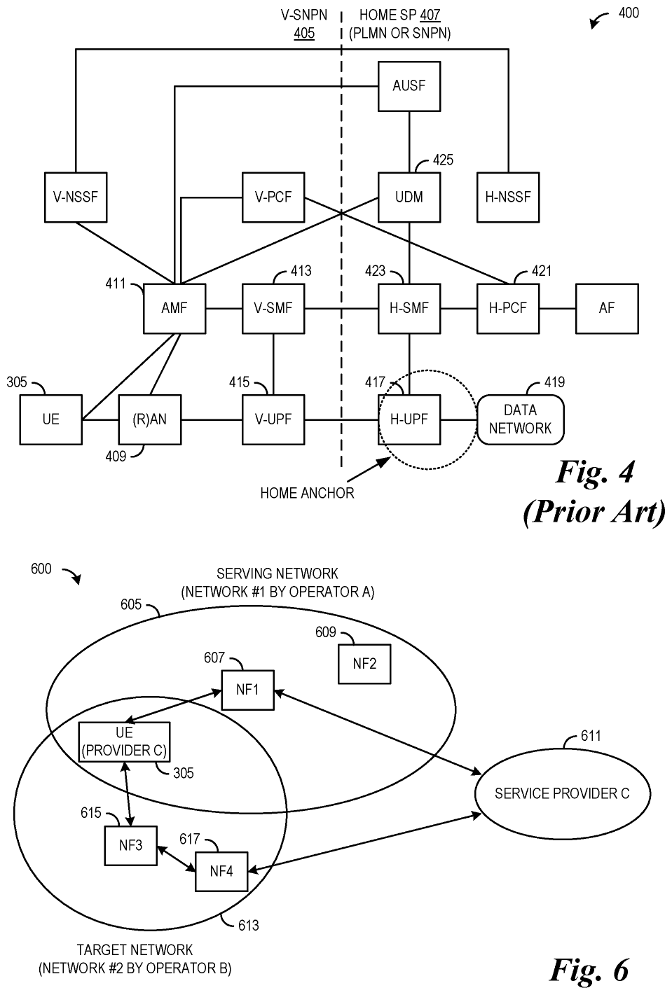

FIG. 4 illustrates a communication system 400 highlighting the prior art technique supporting UE mobility. Communication system 400 includes UE 305 and V-SNPN 405 participating in the UE initiated PDU session establishment procedure, and UE 305 obtains services with home SP 407. Home SP 407 may be a PLMN or a SNPN, for example.

V-SNPN 405 includes a RAN (or AN) 409 that provides connectivity between UE 305 and V-SNPN 405, an access and mobility management function (AMF) 411 that handles connection and mobility management tasks, a visitor session management function (V-SMF) 413 that interacts with the decoupled data plane (including managing PDU sessions), and a visitor user plane function (V-UPF) 415 that provides interconnectivity between RAN 409 and a data network of V-SNPN 405.

Home SP 407 includes a home UPF (H-UPF) 417 that provides interconnectivity between the mobile infrastructure of home SP 407 and data network 419, a home policy charging function (H-PCF) 421 that governs control plane functions, a home SMF (H-SMF) 423 that interacts with the decoupled data plane of home SP 407, and a unified data management (UDM) 425 that consolidates disparate data sources.

FIG. 5 illustrates a diagram 500 of communications exchanged and processing performed by entities participating in the prior art technique supporting UE mobility. The entities participating include UE 305, RAN 409, AMF 411, V-UPF 415, V-SMF 413, H-UPF 417, H-SMF 423, H-PCF 421, and UDM 425.

The prior art technique includes UE 305 sending a PDU session establishment request (event 505), SMF selection for V-SNPN 405 (event 507), UPF selection for V-SNPN 405 (event 509), PDU session authentication and authorization (event 511), and UPF selection for home SP 407 (event 513). The selection of the entities, along with communications exchanged between the entities therewith, establish the PDU session requested by UE 305.

However, the prior art technique is only initiated by UE 305. Therefore, there is no solution where the network (or an entity thereof) can trigger and control the network switch between NPNs (or SNPNs) or between NPN and PLMNs. As an example, the network may trigger the network switch from a first SNPN to a second SNPN for load balancing purposes. Existing network initiated mobility support occurs only within the same network.

Because home SP 407 may have a service level agreement (SLA) with different network providers (NPN, SNPN, PLMN, etc.), home SP 407 may direct UE 305 to different networks supported by the different network providers, where the network that UE 305 is directed to may be based on business need or application. As an example, a hotspot offered by a SNPN is overloaded or some other condition exists that restricts new incoming UEs, home SP 407 may direct a low priority UE to a PLMN that has coverage of the low priority UE and a SLA with home SP 407, while reserving the SNPN for high priority UEs.

Therefore, there is a need for methods and apparatus for supporting network initiated mobility in NPNs (or SNPNs). The methods and apparatus may provide support for network initiated mobility when a UE moves between NPNs (or SNPNs) or between NPNs and PLMNs.

According to an example embodiment, methods and apparatus for supporting network initiated mobility in NPNs are provided. The methods and apparatus provided herein support network initiated mobility of UEs between NPNs or between NPNs and PLMNs. In an embodiment, the network triggers UE mobility, e.g., a network switch, to trigger the UE to perform a mobility procedure to switch to a target network (which may be a NPN, a SNPN, a PN, or a PLMN, for example).

In an embodiment, methods and apparatus wherein the network uses enhanced UE provisioning or configuration capability to send information to the UE, where the information includes target network information. After selecting the target network, the network instructs the UE to switch to the target network. As an example, the network sends a message including information associated with the target network to the UE. The information may be in the form of an identifier of the target network, e.g., a SNPN ID, a PLMN ID, a NPN ID, and so on). The information may be sent in the form of an indicator, such as a network switch indicator. The information may be sent in a UE configuration update procedure, for example.

The indicator may include a trigger to cause the UE to scan the potential target networks and report the scan results to the network. The indicator may also include network switch policy to help the UE make the network switch decision. As an example, the indicator includes a performance threshold (such as an application level performance threshold), or a location trigger for the UE to initiate the network switch.

The information may also include a time or a time duration. The time may specify when the UE shall initiate (or complete, depending on implementation) the mobility procedure to switch to the target network. The time duration may specify a time window within which the UE shall complete (or initiate, depending on implementation) the mobility procedure to switch to the target network. In a situation when the time duration is set to 0, the UE immediately (or as soon as possible) initiates the mobility procedure to switch to the target network.

In an embodiment, methods and apparatus wherein the network uses enhanced application function influence on traffic routing capability by introducing new information regarding the switching network instruction. The new information prepares and triggers the UE to switch to the target network. The network may also prepare the target network for the network switch. As an example, the network updates UE policy information with information associated with the target network and provides the UE policy information to the UE. The information associated with the target network comprises the NPN ID, SNPN ID, PLMN ID, and so on, for example. The network may provide the UE policy information to the UE through a UE configuration update procedure or a UE parameter update procedure, for example. Although the information associated with the target network may be included with a UE route selection policy (URSP) or a new UE policy that includes a new UE route selection rule that includes a traffic descriptor.

In an embodiment, a new message may be used by an application function (AF) to provide a request to the network to instruct the UE to perform activities, including the network switch to the target network, deregistration, etc. In an embodiment, an existing message may be enhanced to provide the request to the network to instruct the UE to perform the activities. An example of such an enhanced message is a UE policy/configuration update message.

In an embodiment, the network utilizes information provided by the UE to select the target network for the network switch. As an example, the network selects the target network based on measurements of potential target networks made by the UE. The potential target networks may be in the form of a preferred network list that is configured by the network and provided to the UE. The UE may use its location to determine the potential target networks and determine signaling status of the potential target networks. The signaling status may be an indication if a potential target network's signal strength meets a signal strength threshold. The UE may use its location to determine the potential target networks and make measurements of transmissions made by the potential target networks. As an example, the potential target networks comprise networks from the preferred network list that are within a distance threshold of the UE. As another example, the potential target networks comprise networks from the preferred network list with transmission measurements exceeding a signal strength threshold. The UE reports the transmission measurements or the signaling status to the network.

In an embodiment, an update to the preferred network list triggers the UE to repeat the measurements of the potential target networks, which may result in the reselection of the target network. As an example, the update to the preferred network list may result in the potential selection of a higher prioritized target network.

As another example, the network selects the target network from measurements of potential target networks made by the network based on the location of the UE. The UE may report its location to the network, or the network may make measurements to determine the location of the UE (e.g., location services (LCS)). Then, based on the location of the UE, the network may query network coverage or status information from potential target networks of the preferred network list that meet a distance threshold or have coverage of the UE. The network may query the potential target networks regarding their performance information, for example.

FIG. 6 illustrates a high-level view of a communication system 600 with support for network initiated mobility in NPNs. Communication system 600 includes UE 305 with a connection provided by a serving network 605. Serving network 605 is operated by operator A, and includes network functions NF1 607 and NF2 609. Serving network 605 may be a NPN or a SNPN, for example. UE 305 is utilizing a service provided by SP C 611. UE 305 is also within coverage of target network 613, which may be a NPN, a SNPN, or a PLMN, for example. Target network includes network functions N3 615 and N4 617.

SP C 611 plans to move UE 305 from serving network 605 to target network 613 while UE 305 is within an overlapping coverage are of both serving network 605 and target network 613. SP C 611 uses information, which includes the preferred network list provided by SP C 611 to UE 305, SP C 611 instructs UE 305 to collect and report transmission measurements of potential target networks, which, in this example, includes target network 613.

SP C 611 selects target network 613 in accordance with the transmission measurements reported by UE 305 and instructs UE 305 to switch to target network 613. SP C 611 interacts with serving network 605 and target network 613 to prepare for the switch between serving network 605 and target network 613. UE 305 performs the network switch and is able to connect to target network 613 without service interruption.

SP C 611 may also be a network operator that also provides network connectivity service to UE 305.

A deployment is considered to present a prior art solution that is UE initiated: UE 305, belonging to a COMPANY, is in an area which is covered by two SNPN networks, a first SNPN provided by Provider_1 and a second SNPN provided by Provider_2. Using the prior art solution, UE 305 will use a stored preferred roaming list associated with COMPANY to pick the first SNPN (Provider_1) or the second SNPN (Provider_2). As an example, UE 305 will pick and use the second SNPN (Provider_2). If the prior art solution is being used, and UE 305 is not moving, UE 305 cannot move to the first SNPN (Provider_1) seamlessly if UE 305 does not lose signal from the second SNPN (Provider_2). Furthermore, the COMPANY cannot direct UE 305, which is moving from the second SNPN (Provider_2) to the first SNPN (Provider_1). In other words, UE 305 has to either manually disconnect from the second SNPN (Provider_2) and select the first SNPN (Provider_1) to connect to on its own, or if UE 305 is moving out coverage of the second SNPN (Provider_2), UE 305 conducts a network scan and selects the first SNPN (Provider_1).

In contrast, the example embodiments presented herein will allow the COMPANY to direct UE 305 to switch from the second SNPN (Provider_2) to the first SNPN (Provider_1) without service interruption while UE 305 is not moving and in the overlapping coverage area of the second SNPN (Provider_2) and the first SNPN (Provider_1).

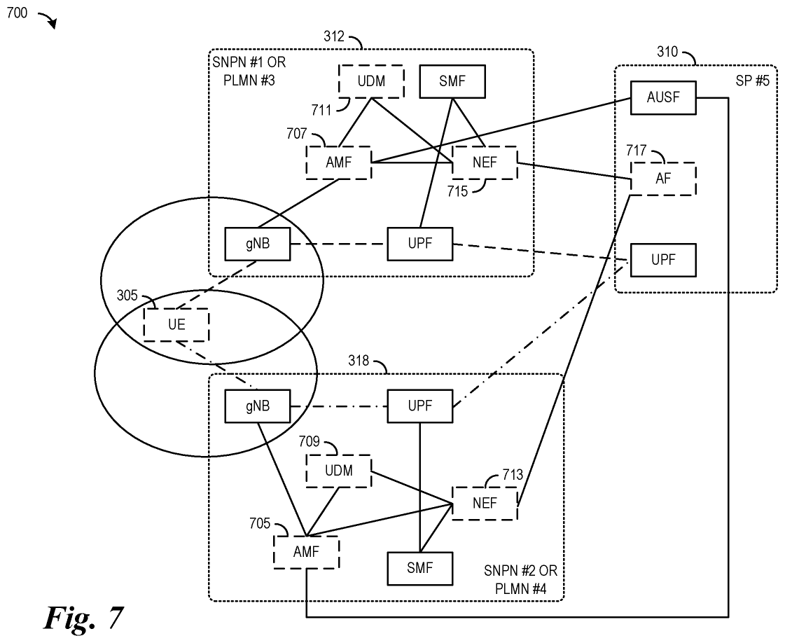

FIG. 7 illustrates the architecture of a first example communication system 700 highlighting entities with enhanced operation to support network initiated mobility. Communication system 700 includes UE 305, SNPN #1 312, SNPN #2 318, and SP 310. Communication system 700 includes entities enhanced to support network initiated mobility. These entities include UE 305, AMFs 705 and 707, UDMs 709 and 711, NEFs 713 and 715, and AF 717. Enhancements to AMFs 705 and 707 include enhancements to the control plane interaction between AMFs 705 and 707 and UE 305 to support network triggered UE mobility HOs between different networks which belong to different operators. Enhancements to NEFs 713 and 715 include enhancements of control interface and adding new information element to exchange mobility message between UE 305 and SP 310, as well as between SP 310 and the underlying network. Enhancements to UE 305 include support for new control plane interaction between AMFs 705 and 707 and UE 305 to support network triggered UE mobility HOs between different networks which belong to different operators, as well as support for new interactions (including a new interface) between UE 305 and SP 310 for the purpose of mobility management. Enhancements to UDMs 709 and 711 include support for storing potential target networks, preferred network lists, steering and connectivity policy. Enhancements to AF 717 include steering information from application aspects.

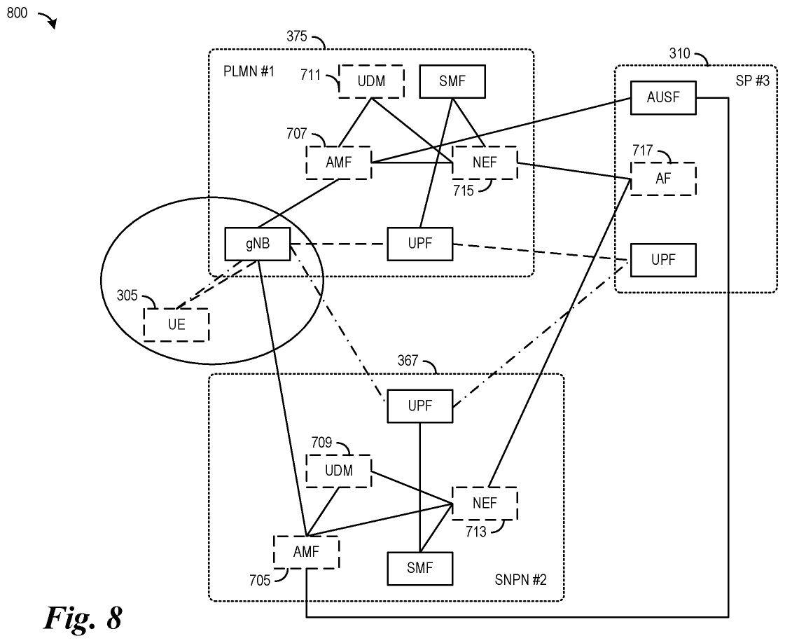

FIG. 8 illustrates the architecture of a second example communication system 800 highlighting entities with enhanced operation to support network initiated mobility. Communication system 800 includes UE 305, PLMN #1 375, SNPN #2 367, and SP 310. Communication system 800 includes entities enhanced to support network initiated mobility. These entities include UE 305, AMFs 705 and 707, UDMs 709 and 711, NEFs 713 and 715, and AF 717. Enhancements to AMFs 705 and 707 include enhancements to the control plane interaction between AMFs 705 and 707 and UE 305 to support network triggered UE mobility HOs between different networks which belong to different operators. Enhancements to NEFs 713 and 715 include enhancements of control interface and adding new information element to exchange mobility message between UE 305 and SP 310, as well as between SP 310 and the underlying network. Enhancements to UE 305 includes support for new control plane interaction between AMFs 705 and 707 and UE 305 to support network triggered UE mobility HOs between different networks which belong to different operators, as well as support for new interactions (including a new interface) between UE 305 and SP 310 for the purpose of mobility management. Enhancements to UDMs 709 and 711 include support for storing potential target networks, preferred network lists, steering and connectivity policy. Enhancements to AF 717 include steering information from application aspects.

As related to SP triggered mobility: The embodiments are for the situation when UE 305 is in the overlapped coverage area from 2 different networks belonging to different operators (SNPN #1 312 or SNPN #2 318 or PLMNs) and can easily switch between the two different networks' RANs, or different core network with a shared RAN.

Example embodiments provide a new mechanism to allow SP 310 to have knowledge of what networks with which UE 305 has coverage before the network switch. This will help SP 310 to make decision on mobility of UE 305. There are several ways to achieve this:
Option 1: Sending instruction information to allow UE 305 to report to SP 310 the potential target networks and their signaling status in the current location of UE 305. This instruction information can be passed to UE 305 from AF 717 by enhancing NEF 713 or 715, or can be conveyed via an application level protocol. UE 305 can follow the instruction to scan and report the scanning result to AF 717. The report can provide the potential SNPN IDs of the potential target networks which are in the preferred network list of UE 305.

The preferred network list can be pre-configured in UE 305, or sent by AF 717 as part of report instruction information. The latter case can be sent from AF 717 to UE 305 via NEF/AMF by enhancing the provision capability of UE 305 or the network monitoring capability of UE 305. If AF 717 provides an updated preferred network list to UE 305 via the serving network, UE 305 may replace its preconfigured or existing preferred network list with the updated preferred network list.

The preferred network list provided by SP 310 can be used by UE 305 for its network selection for initial network access, in addition to the network switch.
Option 2: SP 305, based on the location of UE, queries network coverage and status information from the potential target networks (i.e., target networks which have network coverage of UE 305). This option doesn't require UE changes, but enhances the interaction between SP 310 and the network service providers.
Option 3: A mobility container within the NAS message between UE 305 and AMF 717 is used to carry a common mobility management protocol, such as 802.21 which is dependent on the underlying radio access technologies, in order to support multi-radio-access technology network switches between different networks belonging to different operators.

Because of the differences between PLMNs and NPNs on network selection and network authentication and authorization, AF 717 can provide different target network information to UE 305 for PLMNs and SNPNs, e.g. different IDs, different credentials (3 gpp or non-3 gpp credential), and so on, to be used.

After SP 310 obtains the information on the potential target networks that have the coverage of UE 305, SP 310 can make a decision to switch UE 305 between the networks with which UE 305 is in coverage.

In another embodiment, it is possible to allow SP 310 to provide a preferred network list to UE 305 via provisioning the selection policy to UE 305 from the network management function, such as an access network discovery and selection function (ANDSF) to provide UE 305 with the network selection policy. The network selection function (e.g., the ANDSF) may be located in SP 310, or the service network to which UE 305 is connected. If the network selection function is in the service network, SP 310 can provide the preferred network list to the service network provider via their interaction interface, such as the NEF/AF interface.

In order to move UE from one network to another network, there are several options being provided:
Option 1: SP 310 can use enhanced UE provision/configuration capability provided by service network to send the indication with the target network information to UE 305. After UE 305 receives the instructions, UE 305 may use an existing procedure to move to the target network. Detail procedure example is discussed herein.

The indication can also include the network switch window (a time or time duration) in which UE can perform the network switch. In a situation when the network switch window is set to 0, the UE immediately (or as soon as possible) initiates the mobility procedure to switch to the target network.

The indication can include the trigger to make UE 305 scan all the available networks and report the results to SP 310.

This indication can also include a network switch policy to help UE 305 make a network switch decision, e.g., the performance threshold, including application level performance, or a location trigger for UE to start the network switch.
Option 2: Enhanced application function influence on traffic routing capability by introducing new information of the network switch instruction from SP 310 to serving SNPN (e.g., SNPN #1 312) to prepare and trigger UE 305 to move to another network (i.e., the target network), also additional information or instruction is provided to allow SP 310 to prepare the target network to prepare for the network switch. Detail procedure example is discussed herein.

For both options above, a common container in the existing control messages between UE 305 and network can be introduced to carry the mobility commands from SP 310 to UE 305. Those mobility comments can use other industry standard or protocols, such as 802.21. 3GPP acts as a carrier for those command messages.

The embodiments provide a UE capability indication indicating if UE 305 can support network initiated mobility between different networks belonging to different operators, this indication will be sent by UE 305 to the network or can be set as part of UE subscription information.

The procedure example illustrated below can be also applied to the UE mobility between one SNPN and one PLMN, or between PLMNs.

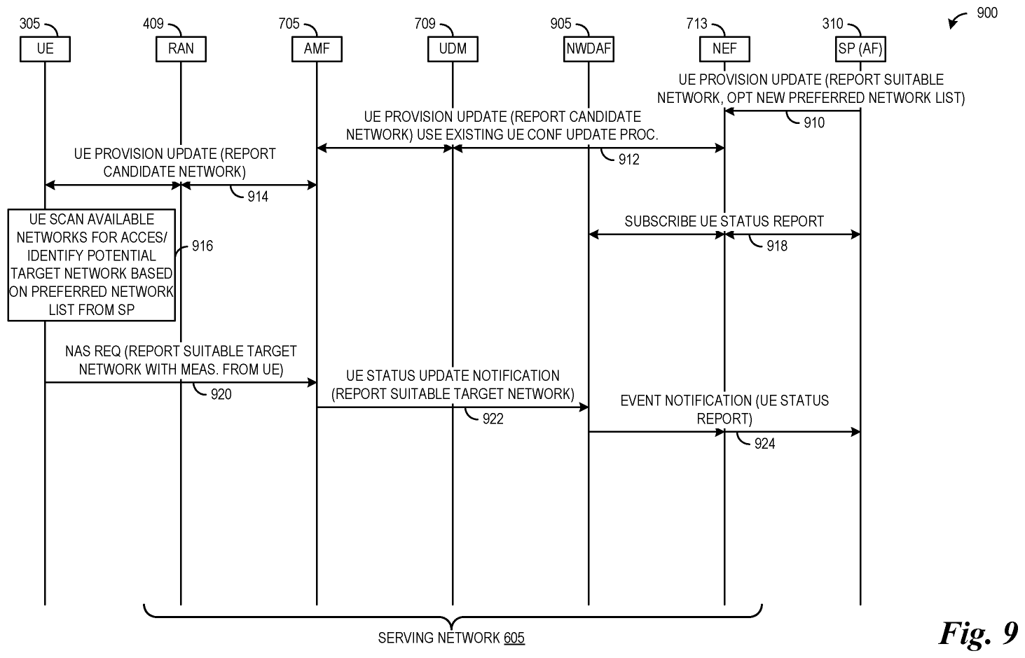

FIG. 9 illustrates a diagram 900 of communications exchanged and processing performed by entities participating in a UE reporting potential target networks procedure. The communications and processing reuse existing 3GPP functions and procedures, but with embodiment information elements (IEs), for example. The entities participating include UE 305, RAN 409, AMF 705, UDM 709, a network data analytics function (NWDAF) 905, NEF 713, SP 310 (through AF 717). RAN 409, AMF 705, UDM 709, NWDAF 905, and NEF 713 are NFs of serving network 605.

SP 310 requests UE 305 to report potential target networks by sending a UE provision update message to NEF 713 (event 910). The UE provision update message includes an indicator indicating UE 305 to report potential target networks. The UE provision update message may optionally include a new or updated preferred network list. NEF 713 sends the UE provision update message to UDM 709, which sends the UE provision update message to AMF 705 (event 912). The UE provision update message may be sent to UDM 709 (and then AMF 705) through the use of a UE configuration update procedure. The existing UE configuration update procedure may be used. The UE provision update message includes the indicator indicating UE 305 to report potential target networks. The UE provision update message may optionally include the new or updated preferred network list.

AMF 705 sends the UE provision update message to UE 305 (event 914). The UE provision update message may be sent to UE 305 through RAN 409, for example. The UE provision update message includes the indicator indicating UE 305 to report potential target networks. The UE provision update message may optionally include the new or updated preferred network list. UE 305 identifies potential target networks (block 916). UE 305 may identify potential target networks by scanning available networks for access, and identify potential target networks based on the preferred network list from SP 310 and results of the scan. As an example, UE 305 scans available networks and compares the results of the scan with the preferred network list, where the potential target networks comprise networks that are both in the results of the scan and the preferred network list, as well as satisfy any requirements or restrictions associated with the networks found in the scan.

SP 310 subscribe to UE status reports (event 918). Subscribing to UE status reports involves a message exchange with NEF 713 and NWDAF 905. Subscribing to UE status reports enables SP 310 being notified of changes in the status of UE 305. As an example, if NWDAF 905 detects a change in the status of UE 305, NWDAF 905 sends an update to SP 310, as well as other network entities subscribed to UE status reports of UE 305.

UE 305 sends a network access stratum (NAS) message to AMF 705 to report the potential target networks (event 920). The NAS message includes the potential target networks (e.g., identifiers of the potential target networks) and optionally measurements (e.g., signal strength measurements) of the potential target networks. UE 305 sends a UE status update notification to NWDAF 905 to report the potential target networks (event 922). The UE status update notification includes the potential target networks (e.g., identifiers of the potential target networks), for example. NWDAF 905 sends an event notification to NEF 713, which forwards the event notification to SP 310, to report the potential target networks (event 924). The event notification includes the report of the potential target networks (and optionally measurements of the potential status reports).

In an embodiment, the report of the potential target networks (and optionally the measurements of the potential target methods) is invisible to serving network 605, which implies that the report is encrypted or encapsulated in the control messages being transferred through serving network 605. The control messages include those being transferred in events 920, 922, and 924.

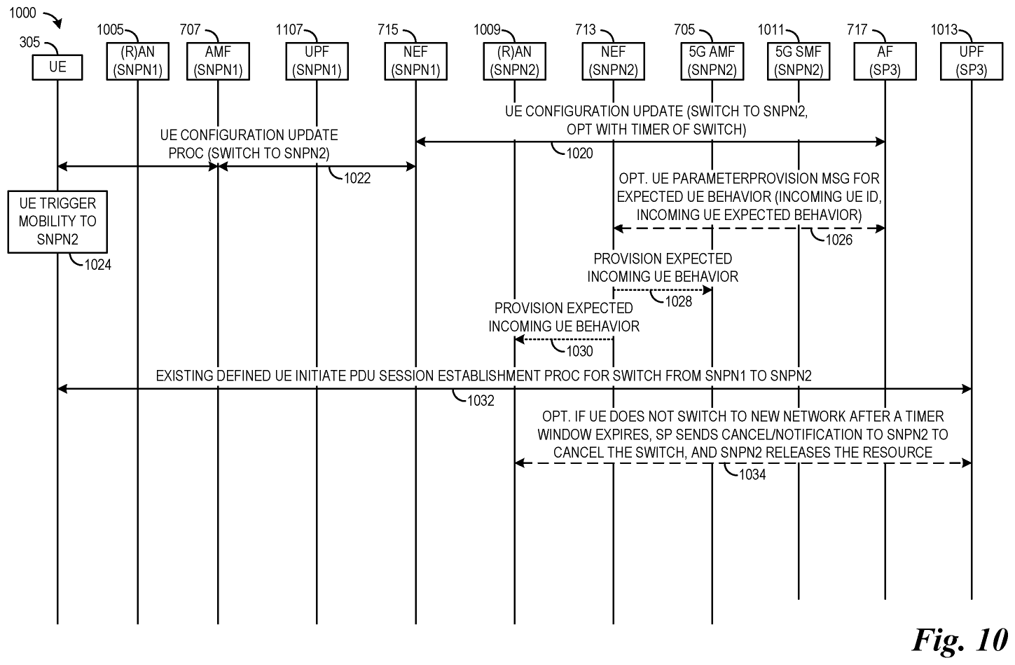

FIG. 10 illustrates a diagram woo of communications exchanged and processing performed by entities participating in a first example network triggered network switch. The first example network triggered network switch is triggered by sending an indication indicating a network switch. The communications and processing reuse existing 3GPP functions and procedures, but with embodiment information elements (IEs), for example. The entities participating include UE 305, RAN 1005 (of SNPN #1 312), AMF 707 (of SNPN #1 312), UPF 1007 (of SNPN #1 312), NEF 715 (of SNPN #1 312), RAN 1009 (of SNPN #2 318), NEF 713 (of SNPN #2 318), AMF 705 (of SNPN #2 318), SMF 1011 (of SNPN #2 318), AF 717 (of SP 310), and UPF 1013 (of SP 310).

SP 310, through AF 717, transfers a UE configuration update to NEF 715 (event 1020). The UE configuration update includes an indicator indicating UE 305 to switch from SNPN #1 312 to SNPN #2 318. The UE configuration update may optionally include a time or a time duration associated with the network switch. As an example, the time specifies a time before which UE 305 should start or complete the network switch. As another example, the time duration specifies a time window within which UE 305 should start or complete the network switch. In a situation when the time duration is set to 0, the UE immediately (or as soon as possible) initiates the mobility procedure to switch to the target network.

NEF 715, AMF 707, and UE 305 participate in a UE configuration update procedure (event 1022). Participation in the UE configuration update procedure transfers the indicator indicating UE 305 to switch from to SNPN #2 318 to UE 305. UE 305 triggers the network switch to SNPN #2 318 (block 1024). An existing UE initiated PDU session establishment procedure is performed (block 1032). The UE initiated PDU session establishment procedure is used to switch UE 305 from SNPN #1 312 to SNPN #2 318.

As an option, AF 717 and NEF 713 share a UE parameter provision message for expected UE behavior of UE 305 (event 1026). The UE parameter provision message allows SP 310 to notify SNPN #2 318 (the target network) to prepare for UE 305 (the incoming UE), for a fast network switch, for example. This enhances the existing network notification of NEF 713 for expected UE behavior. The UE parameter provision message includes an identifier of UE 305 (the incoming UE) and expected behavior of UE 305. NEF 713 provisions the expected UE behavior of UE 305 to AMF 705 (event 1028) and RAN 1109 (event 1030).

As an option, if UE 305 does not switch to SNPN #2 318 before the time or time duration specified, SP 310 sends a cancel or notification message to SNPN #2 318 to cancel the network switch (event 1034). SNPN #2 318 also releases any resources allocated to UE 305 and the network switch.

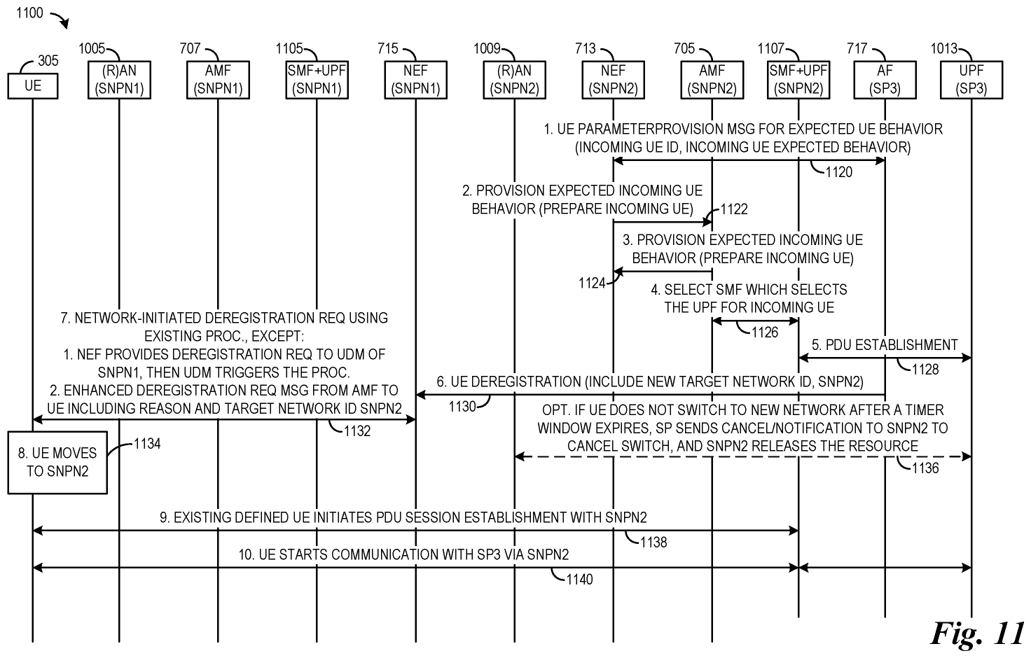

FIG. 11 illustrates a diagram 1100 of communications exchanged and processing performed by entities participating in a second example network triggered network switch. The second example network triggered network switch is triggered by updating UE policy information. The communications and processing reuse existing 3GPP functions and procedures, but with embodiment information elements (IEs), for example. The entities participating include UE 305 (the incoming UE), RAN 1005 (of SNPN #1 312), AMF 707 (of SNPN #1 312), SMF+UPF 1105 (of SNPN #1 312), NEF 715 (of SNPN #1 312), RAN 1009 (of SNPN #2 318), NEF 713 (of SNPN #2 318), AMF 705 (of SNPN #2 318), SMF+UPF 1107 (of SNPN #2 318), AF 717 (of SP 310), and UPF 1013 (of SP 310).

SP 310, through AF 717, updates the expected UE behavior by transferring a UE parameter provisioning message for expected UE behavior to NEF 713 (event 1120). The UE parameter provisioning message for expected UE behavior includes an identifier of the incoming UE (i.e., UE 305) and the expected behavior of UE 305. NEF 713 provisions the expected incoming UE behavior to prepare UE 305 by transferring the expected incoming UE behavior to AMF 705 (event 1122). AMF 705 responds to NEF 713 provisioning the expected incoming UE behavior (event 1124).

AMF 705 selects a SMF (e.g., SMF+UPF 1107) which, in turn, selects a UPF for UE 305 (event 1126). SMF+UPF 1107 and UPF 1013 (of SP 310) participate in a PDU establishment procedure (event 1128).

AF 717 transfers a UE deregistration message to NEF 715 (event 1130). The UE deregistration message includes the network identifier of the target network (SNPN #2 318) that UE 305 is to switch over to. NEF 715 sends to UE 305 a network initiated deregistration request (event 1132). The network initiated deregistration request may be sent using existing processes, with exceptions:

1) NEF 715 provides the deregistration request to the UDM of SNPN #1 312, then the UDM triggers the process; and

2) The network initiated deregistration request message from AMF 707 to UE 305 includes a reason for the deregistration, and an identifier of the target network, e.g., SNPN #2 318.

UE 305 HOs to SNPN #2 318 (block 1134). As an option, if UE 305 does not switch to SNPN #2 318 before the time or time duration specified, SP 310 sends a cancel or notification message to SNPN #2 318 to cancel the network switch (event 1136). SNPN #2 318 also releases any resources allocated to UE 305 and the network switch.

UE 305 initiates a PDU session establishment procedure with SNPN #2 318 (event 1138). The PDU session establishment procedure establishes a data connection between UE 305 and SNPN #2 318, for example. UE 305 communicates with SP 310 via SNPN #2 318 (event 1140).

In an embodiment, event 1120 between AF 717 and NEF 713 allows SP 310 to notify the target network (SNPN #2 318) to prepare for UE 305 for a fast network switch, which enhances the existing network notification of NEF 713 for the expected UE behavior. Alternatively, a new message between AF 717 and NEF 713 may be used to deliver information related to UE 305 to the target network.

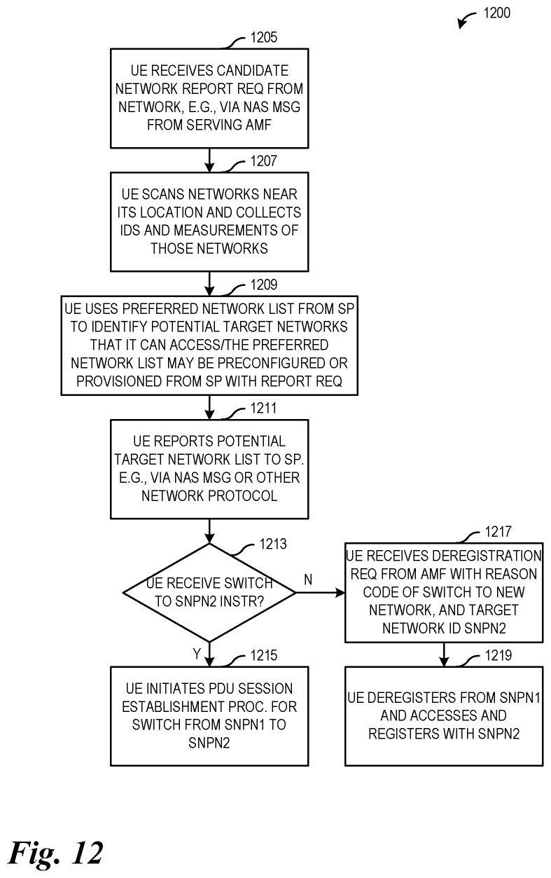

FIG. 12 illustrates a flow diagram of example operations 1200 occurring in a UE participating in network initiated mobility. Operations 1200 may be indicative of operations occurring in a UE, such as UE 305, as the UE participates in network initiated mobility.

Operations 1200 begin with the UE receiving a candidate network report request (block 1205). The candidate network report request may be received from the SP servicing the UE, for example. The candidate network report request may be received by way of a NAS message from the AMF of the SP, for example. The UE scans for networks (block 1207). The UE scans for networks near its location and collects identifiers and signal measurements (e.g., signal strength measurements) of the networks, for example.

The UE utilizes the preferred network list to identify potential target networks (block 1209). The UE uses the results of the scan (block 1207) and the preferred network list to identify potential target networks that it can access. As an example, there may be some networks that the UE is able to scan, but these networks will not grant access to the UE. Access to these networks may be limited due to subscription type, UE priority, network load, etc.

The UE reports the potential target networks (block 1211). As an example, the UE reports a list of the potential target networks to the SP. The list may include identifiers of the potential target networks. The list may also include information about the signal measurements of the potential target networks. The report may be sent to the SP by way of a NAS message, for example. As another example, the report may be sent to the SP using any other network protocol.

The UE performs a check to determine if it has received a network switch instruction (block 1213). The UE may perform a check to determine if a network switch instruction has been received, instructing the UE to switch to the target network, e.g., SNPN #2, as specified in the network switch instruction. The network may be one of the potential target networks previously reported by the UE.

If the UE has received the network switch instruction, the UE initiates a PDU session establishment procedure to switch from its serving network (e.g., SNPN #1) to the target network (e.g., SNPN #2) (block 1215). The PDU session establishment procedure performed by the UE may be as described above, for example.

If the UE has not received the network switch instruction, the UE receives a deregistration request (block 1217). The deregistration request may be received from the AMF of the SP, for example, and includes a reason code for the switch to the target network. The deregistration request may also include the identifier of the target network, e.g., SNPN #2. The UE deregisters from its serving network (e.g., SNPN #1) and accesses and registers with the target network (e.g., SNPN #2) (block 1219). The registration with the target network utilizes the identifier of the target network provided in the deregistration request, for example.

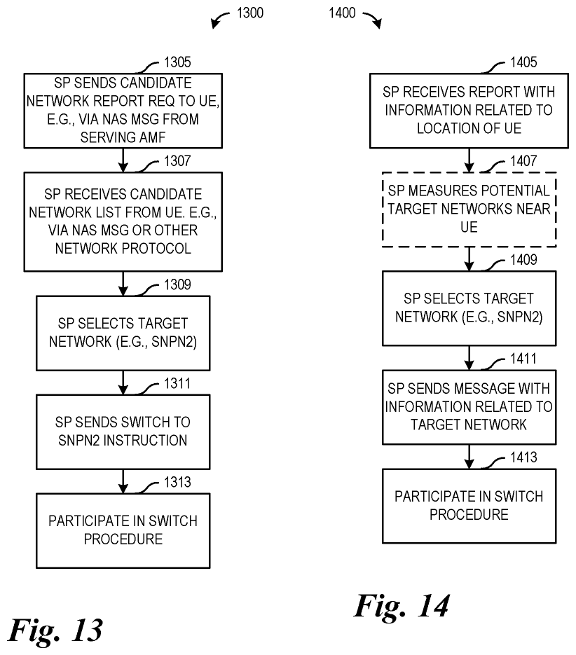

FIG. 13 illustrates a flow diagram of example operations 1300 occurring in a SP participating in network initiated mobility. Operations 1300 may be indicative of operations occurring in a SP, such as SP 310, as the SP participates in network initiated mobility.

Operations 1300 begin with the SP sending a candidate network report request (block 1305). The candidate network report request may be sent to the UE serviced by the SP, for example. The candidate network report request may be sent using a NAS message. The SP receives a report of the potential target networks (block 1307). The report of potential target networks may be in the form of a list that includes identifiers of the potential target networks. The list may also include information about the signal measurements of the potential target networks.

The SP selects the target network (block 1309). The SP selects the target network from the report received from the UE, for example. The selection of the target network may be based on a selection criterion, which may include network load, UE subscription level, UE priority, and so on.

The SP sends the network switch instruction (block 1311). The network switch instruction may be sent to the UE, for example. The network switch instruction instructs the UE to switch to the target network, e.g., SNPN #2. The network switch instruction includes the identifier of the target network, and may optionally include a time or time duration for the UE to start or complete the network switch. In an embodiment, if the SP does not send the network switch instruction, the SP may alternatively, send a deregistration request. The deregistration request includes a reason code for the network switch to the target network. The deregistration request may also include the identifier of the target network, e.g., SNPN #2. The SP participates in the network switch procedure (block 1313).

FIG. 14 illustrates a flow diagram of example operations 1400 occurring in a SP initiating network initiated mobility. Operations 1400 may be indicative of operations occurring in a SP, such as SP 310, as the SP initiates network initiated mobility.

Operations 1400 begin with the SP receiving a report with information related to the location of the UE (block 1405). The report may be received from the UE. As an example, the report includes information related to potential target networks that are in close proximity to the UE. The potential target networks may meet a distance threshold with respect to the UE or the signal strength of transmissions of the potential target networks may meet a signal strength threshold, for example. As another example, the report includes information related to the location of the UE.

Optionally, the SP measures the potential target networks (block 1407). In the situation where the reports includes the information related to the location of the UE, the SP identifies potential target networks that meet a distance threshold with respect to the UE or makes measurements of the signal strength of transmissions of the potential target networks may meet a signal strength threshold, for example.

The SP selects the target network (block 1409). The SP selects the target network from the potential target networks based on the selection criterion, for example. Examples of the selection criterion may include network load, UE subscription level, UE priority, and so on. The SP sends a message with information related to the target network (block 1411). The message may be sent to the UE, for example. The message may include an identifier of the target network, and optionally, a time or time duration for the UE to start or complete the network switch. The SP participates in the network switch procedure (block 1413).

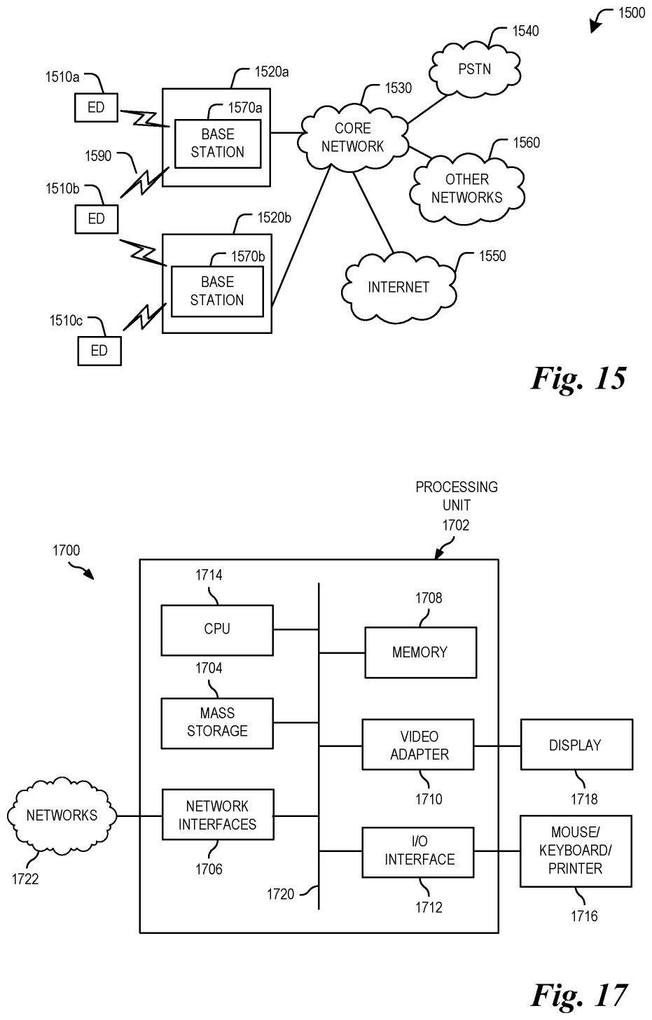

FIG. 15 illustrates an example communication system 1500. In general, the system 1500 enables multiple wireless or wired users to transmit and receive data and other content. The system 1500 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1500 includes electronic devices (ED) 1510a-1510c, radio access networks (RANs) 1520a-1520b, a core network 1530, a public switched telephone network (PSTN) 1540, the Internet 1550, and other networks 1560. While certain numbers of these components or elements are shown in FIG. 15, any number of these components or elements may be included in the system 1500.

The EDs 1510a-1510c are configured to operate or communicate in the system 1500. For example, the EDs 1510a-1510c are configured to transmit or receive via wireless or wired communication channels. Each ED 1510a-1510c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1520a-1520b here include base stations 1570a-1570b, respectively. Each base station 1570a-1570b is configured to wirelessly interface with one or more of the EDs 1510a-1510c to enable access to the core network 1530, the PSTN 1540, the Internet 1550, or the other networks 1560. For example, the base stations 1570a-1570b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1510a-1510c are configured to interface and communicate with the Internet 1550 and may access the core network 1530, the PSTN 1540, or the other networks 1560.

In the embodiment shown in FIG. 15, the base station 1570a forms part of the RAN 1520a, which may include other base stations, elements, or devices. Also, the base station 1570b forms part of the RAN 1520b, which may include other base stations, elements, or devices. Each base station 1570a-1570b operates to transmit or receive wireless signals within a particular geographic region or area, sometimes referred to as a “cell.” In some embodiments, multiple-input multiple-output (MIMO) technology may be employed having multiple transceivers for each cell.

The base stations 1570a-1570b communicate with one or more of the EDs 1510a-1510c over one or more air interfaces 1590 using wireless communication links. The air interfaces 1590 may utilize any suitable radio access technology.

It is contemplated that the system 1500 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1520a-1520b are in communication with the core network 1530 to provide the EDs 1510a-1510c with voice, data, application, Voice over Internet Protocol (VoIP), or other services. Understandably, the RANs 1520a-1520b or the core network 1530 may be in direct or indirect communication with one or more other RANs (not shown). The core network 1530 may also serve as a gateway access for other networks (such as the PSTN 1540, the Internet 1550, and the other networks 1560). In addition, some or all of the EDs 1510a-1510c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1550.

Although FIG. 15 illustrates one example of a communication system, various changes may be made to FIG. 15. For example, the communication system 1500 could include any number of EDs, base stations, networks, or other components in any suitable configuration.

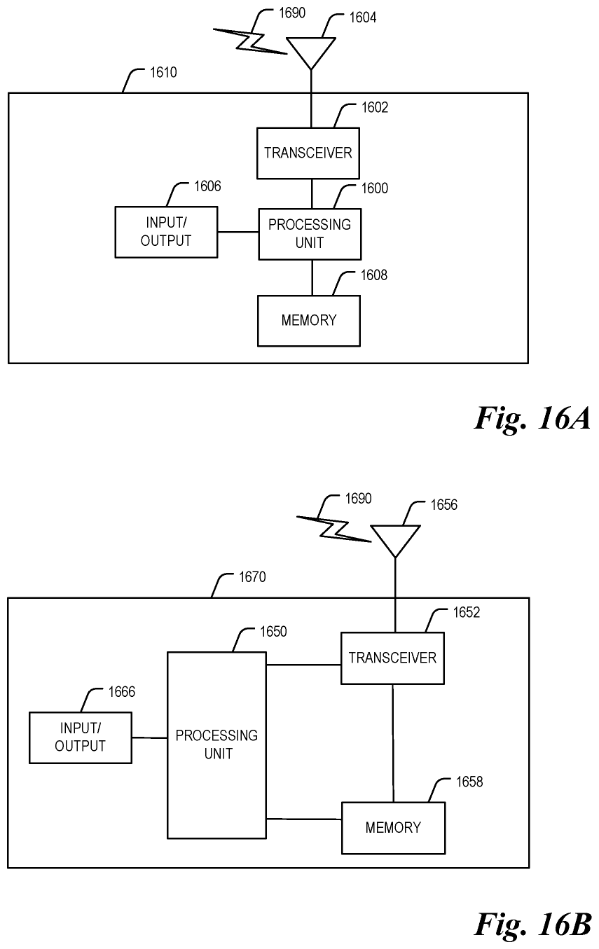

FIGS. 16A and 16B illustrate example devices that may implement the methods and teachings according to this disclosure. In particular, FIG. 16A illustrates an example ED 1610, and FIG. 16B illustrates an example base station 1670. These components could be used in the system 1500 or in any other suitable system.

As shown in FIG. 16A, the ED 1610 includes at least one processing unit 1600. The processing unit 1600 implements various processing operations of the ED 1610. For example, the processing unit 1600 could perform signal coding, data processing, power control, input/output processing, or any other functionality enabling the ED 1610 to operate in the system 1500. The processing unit 1600 also supports the methods and teachings described in more detail above. Each processing unit 1600 includes any suitable processing or computing device configured to perform one or more operations. Each processing unit 1600 could, for example, include a microprocessor, microcontroller, digital signal processor, field programmable gate array, or application specific integrated circuit.

The ED 1610 also includes at least one transceiver 1602. The transceiver 1602 is configured to modulate data or other content for transmission by at least one antenna or NIC (Network Interface Controller) 1604. The transceiver 1602 is also configured to demodulate data or other content received by the at least one antenna 1604. Each transceiver 1602 includes any suitable structure for generating signals for wireless or wired transmission or processing signals received wirelessly or by wire. Each antenna 1604 includes any suitable structure for transmitting or receiving wireless or wired signals. One or multiple transceivers 1602 could be used in the ED 1610, and one or multiple antennas 1604 could be used in the ED 1610. Although shown as a single functional unit, a transceiver 1602 could also be implemented using at least one transmitter and at least one separate receiver.

The ED 1610 further includes one or more input/output devices 1606 or interfaces (such as a wired interface to the Internet 1550). The input/output devices 1606 facilitate interaction with a user or other devices (network communications) in the network. Each input/output device 1606 includes any suitable structure for providing information to or receiving information from a user, such as a speaker, microphone, keypad, keyboard, display, or touch screen, including network interface communications.

In addition, the ED 1610 includes at least one memory 1608. The memory 1608 stores instructions and data used, generated, or collected by the ED 1610. For example, the memory 1608 could store software or firmware instructions executed by the processing unit(s) 1600 and data used to reduce or eliminate interference in incoming signals. Each memory 1608 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 16B, the base station 1670 includes at least one processing unit 1650, at least one transceiver 1652, which includes functionality for a transmitter and a receiver, one or more antennas 1656, at least one memory 1658, and one or more input/output devices or interfaces 1666. A scheduler, which would be understood by one skilled in the art, is coupled to the processing unit 1650. The scheduler could be included within or operated separately from the base station 1670. The processing unit 1650 implements various processing operations of the base station 1670, such as signal coding, data processing, power control, input/output processing, or any other functionality. The processing unit 1650 can also support the methods and teachings described in more detail above. Each processing unit 1650 includes any suitable processing or computing device configured to perform one or more operations. Each processing unit 1650 could, for example, include a microprocessor, microcontroller, digital signal processor, field programmable gate array, or application specific integrated circuit.

Each transceiver 1652 includes any suitable structure for generating signals for wireless or wired transmission to one or more EDs or other devices. Each transceiver 1652 further includes any suitable structure for processing signals received wirelessly or by wire from one or more EDs or other devices. Although shown combined as a transceiver 1652, a transmitter and a receiver could be separate components. Each antenna 1656 includes any suitable structure for transmitting or receiving wireless or wired signals. While a common antenna 1656 is shown here as being coupled to the transceiver 1652, one or more antennas 1656 could be coupled to the transceiver(s) 1652, allowing separate antennas 1656 to be coupled to the transmitter and the receiver if equipped as separate components. Each memory 1658 includes any suitable volatile or non-volatile storage and retrieval device(s). Each input/output device 1666 facilitates interaction with a user or other devices (network communications) in the network. Each input/output device 1666 includes any suitable structure for providing information to or receiving/providing information from a user, including network interface communications.

FIG. 17 is a block diagram of a computing system 1700 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1700 includes a processing unit 1702. The processing unit includes a central processing unit (CPU) 1714, memory 1708, and may further include a mass storage device 1704, a video adapter 1710, and an I/O interface 1712 connected to a bus 1720.

The bus 1720 may be one or more of any type of several bus architectures including a memory bus or memory controller, a peripheral bus, or a video bus. The CPU 1714 may comprise any type of electronic data processor. The memory 1708 may comprise any type of non-transitory system memory such as static random access memory (SRAM), dynamic random access memory (DRAM), synchronous DRAM (SDRAM), read-only memory (ROM), or a combination thereof. In an embodiment, the memory 1708 may include ROM for use at boot-up, and DRAM for program and data storage for use while executing programs.

The mass storage 1704 may comprise any type of non-transitory storage device configured to store data, programs, and other information and to make the data, programs, and other information accessible via the bus 1720. The mass storage 1704 may comprise, for example, one or more of a solid state drive, hard disk drive, a magnetic disk drive, or an optical disk drive.

The video adapter 1710 and the I/O interface 1712 provide interfaces to couple external input and output devices to the processing unit 1702. As illustrated, examples of input and output devices include a display 1718 coupled to the video adapter 1710 and a mouse, keyboard, or printer 1716 coupled to the I/O interface 1712. Other devices may be coupled to the processing unit 1702, and additional or fewer interface cards may be utilized. For example, a serial interface such as Universal Serial Bus (USB) (not shown) may be used to provide an interface for an external device.

The processing unit 1702 also includes one or more network interfaces 1706, which may comprise wired links, such as an Ethernet cable, or wireless links to access nodes or different networks. The network interfaces 1706 allow the processing unit 1702 to communicate with remote units via the networks. For example, the network interfaces 1706 may provide wireless communication via one or more transmitters/transmit antennas and one or more receivers/receive antennas. In an embodiment, the processing unit 1702 is coupled to a local-area network 1722 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a measuring unit or module, a selecting unit or module, a determining unit or module, a querying unit or module, or a reporting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

1. A method comprising:
receiving, by a user equipment (UE) from a home service provider (SP) of the UE, a first message including information associated with one or more target networks, the first message initiating a network switch process changing a serving network of the UE from a current network to one target network of the one or more target networks;
obtaining, by the UE, a preferred network list;
selecting, by the UE, a target network of the one or more target networks; and
accessing, by the UE, the target network.

2. The method of claim 1, the first message being received in a message for policy configuration, the message for policy configuration indicating the preferred network list, the obtaining comprising:
obtaining, by the UE, the preferred network list from the message for policy configuration.

3. The method of claim 1, the obtaining comprising:
receiving, by the UE, a policy configuration message sent by a network management function, the policy configuration message indicating the preferred network list.

4. The method of claim 3, the network management function being a management function for access network selection management including at least one of an access network discovery and selection policy (ANDSP) or an access network discovery and selection function (ANDSF).

5. The method of claim 1, the preferred network list including a list of private networks belonging to SPs different from the home SP.

6. The method of claim 1, the home SP owning a service subscription of the UE for a service or application the UE is accessing through the serving network.

7. The method of claim 1, the one or more target networks comprising private networks belonging to SPs different from the home SP.

8. The method of claim 1, the first message comprising a network switch indication or a network steering indication.

9. The method of claim 1, further comprising:
receiving, by the UE from the home SP, a second message including network information associated with one or more candidate networks of the network switch process involving the UE, the second message being received prior to receiving the first message;
measuring, by the UE, the one or more candidate networks in accordance with the network information; and
reporting, by the UE to the home SP, measurement information associated with the one or more candidate networks.

10. The method of claim 9, the first message or the second message being received in one of a UE configuration procedure or a parameter update procedure.

11. The method of claim 9, the second message comprising a UE network switch policy.

12. The method of claim 9, the network information comprising identifiers of the one or more candidate networks, and identifiers of one or more SPs of the one or more candidate networks.

13. The method of claim 9, the measurement information comprising, for each one of the one or more candidate networks, an indicator indicating if a signal strength of the each one of the one or more candidate networks is suitable for the UE.

14. The method of claim 1, the first message being received in a dedicated network control message steering the UE from the current network to the one target network.

15. The method of claim 1, the first message being received in a policy configuration message steering the UE from the current network to the one target network based on a service connectivity policy.

16. The method of claim 1, the first message further comprising a time window duration for completing or start the network switch process.

17. The method of claim 16, wherein, when the time window duration is equal to zero, the UE starts the network switch process as soon as possible.

18. The method of claim 1, the first message comprising a network switch policy to assist the UE make a switch decision, the network switch policy comprising a performance threshold or a location trigger for the UE to start the network switch process, and the performance threshold comprising an application level performance.

19. A method comprising:
receiving, by a home service provider (SP) from a user equipment (UE), a report including information associated with a location of the UE;
selecting, by the home SP, one or more target networks in accordance with the information;
sending, by the home SP to the UE, a first message including information associated with the one or more target networks, the first message initiating a network switch process changing a serving network of the UE from a current network to one target network of the one or more target networks; and
sending, by the home SP to the UE, a preferred network list.

20. A user equipment (UE) comprising:
at least one processor; and
a non-transitory computer readable storage medium storing programming, the programming including instructions that, when executed by the at least one processor, cause the UE to perform operations including:
receiving, from a home service provider (SP) of the UE, a first message including information associated with one or more target networks, the first message initiating a network switch process changing a serving network of the UE from a current network to one target network of the one or more target networks;
obtaining a preferred network list;
selecting a target network of the one or more target networks; and
accessing the target network.
